(19) United States
(12) Patent Application Publication
(10) Pub. No.: US 2007/0230787 A1
(43) Pub. Date: Oct. 4, 2007

(54) Method for automated processing of hard copy text documents

(75) Inventors: Alena V. Belitskaya, Venlo (NL); Bernd Faust, Venlo (NL); Henricus M. Dortmans, Panningen (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/730,548

(22) Filed: Apr. 2, 2007

(30) Foreign Application Priority Data
Apr. 3, 2006 (EP) 06112153

(51) Int. Cl. G06K 9/18

(52) U.S. Cl. 382/182

(57) ABSTRACT

A method for automated processing of hard copy text documents includes scanning the hard copy document, subjecting the scanned document to an OCR process, so as to obtain a text file of the text of the document and subjecting the text file to a Named Entities (NE) recognition process. The NE recognition process includes detecting OCR recognition errors in the text file.

### CROSS-REFERENCE TO RELATED APPLICATIONS

This nonprovisional application claims priority under 35 U.S.C. § 119(a) on Patent Application No. 06112153, filed in The Netherlands on Apr. 3, 2006, the entirety of which is incorporated herein by reference.

### BACKGROUND OF THE INVENTION

1. Field of the Invention:

The present invention relates to a method for automated processing of hard copy text documents. In particular, the present invention relates to method for recognition of named entities within a multilingual document text that is heavily degraded by OCR/spelling errors.

2. Background of the Invention:

The recognition of named Entities in a text file is a well-studied task in the field of electronic processing of natural language. Its objective is to identify the boundaries of certain phrases in a text, which are normally not found in a dictionary of a language, but function as unique identifiers of entities (organizations, persons, locations, etc.), times (dates, times) and quantities (monetary values, percentages, etc.). The named entities may thus be classified as proper names such as “Henry Miller,” “New York,” “United Nations Organization”; temporal expressions such as “boundaries of certain phrases in a text, which are normally not found in a dictionary of a Jul. 1, 2005,” “11.30 a.m.,”; and numerical expressions such as “100 km/h,” “52.48 $/barrel” and the like. The recognition and classification of such named entities in a text file provides useful information for many other tasks in the field of automated text and document processing, including, for example, spelling check and spelling correction, template filling, automated generation of a digest or a list of catchwords for document retrieval, search engines and the like, categorization and classification of documents, and many more. As a representative example, one may think of the task of anonymizing a document, e.g., a court decision, by detecting and replacing the names of persons, companies and the like, in order to protect the privacy of the parties involved.

Methods of Named Entity recognition, which are discussed, for example, by D. Palmer, D. Day, “A Statistical Profile of the Named Entity Task”, Proceedings of the Fifth Conference on Applied Natural Language Processing, Washington, D.C., Mar. 31-Apr. 3, 1997 and by Andrei Mikheev, Marc Moens and Claire Grover, “Named Entity Recognition without Gazetteers, in Proceedings of EACL '99, Bergen, Norway, 1999, pp. 1-8, are based on at least one or, more preferably, a combination of two fundamental approaches: reference to patterns and reference to gazetteers.

The pattern-based approach takes advantage of the fact that many named entities can be recognized by means of a characteristic pattern occurring either in the named entity phrase itself or in the context thereof. For example, characteristic patterns for names of persons are “Mrs. Xxxx” or “Mr. Xxxx X. Xxxx” as in “Mrs. Robinson” or “Mr. Richard K. Lee,” or patterns including a title such as “President John F. Kennedy” or “Professor Max von Laue.” Typical patterns for company names are “Xxxx B.V.,” “Xxxx GmbH” or “Xxxx Ltd.”

Named Entities may also be recognised by reference to characteristic patterns in their context. For example, phrases like “my name is . . . ” or “name: . . . ” indicate that the expression following to this phrase will be a name of a person. A context phrase like “Xxxx, chairman of Yyyy” will indicate that “Xxxx” is a name of a person and “Yyyy” is a name of a company or organization.

A gazetteer is a list of phrases that are known to designate named entities. Thus, a named entity appearing in a text file can be recognized by checking whether a phrase appearing in the text file matches with a phrase that is listed in one or more gazetteers. Of course, the comprehensiveness of the gazetteers and the selection of named entities included therein will depend on the specific field of application. For example, when processing political newspaper articles, it will be useful to have a gazetteer which includes the names of all countries and major cities all over the world, names of well known politicians, and the like. In the field of scientific literature, a useful gazetteer would include the names of famous scientists and scientific organizations.

A powerful algorithm for NE recognition will combine these two approaches and may employ dynamic or self-learning gazetteers. For example, once a named entity such as “Fischer & Krecke GmbH” has been identified as a company name because of its characteristic pattern, the phrase “Fischer & Krecke” may automatically be added to a gazetteer for company names, so that, when “Fischer & Krecke” is later found in the same document or another document, it can be recognized as a company name even if it does not fit into the pattern, i.e. is not accompanied by the expression “GmbH.”

In many practical applications, the text file that is to be subjected to NE recognition will be a text file that has been created electronically on a computer. It is possible, however, that NE recognition is also employed or should be employed in a document processing workflow, wherein the text documents are originally presented in the form of hard copies which have to be scanned-in and then have to be subjected to an Optical Character Recognition (OCR) process in order to obtain a text file to which NE recognition can be applied. The results of NE recognition may then be utilized, for example, for distributing the documents further to their respective destinations, either as hard copies or in electronic form, for archiving the documents or for creating new hard copies of soft copy documents by changing the original text, e.g. in order to anonymize the same.

AZZABOU N et al.: “Neural network-based proper names extraction in fax images” PATTERN RECOGNITION, 2004, ICPR 2004. PROCEEDINGS OF THE 17TH INTERNATIONAL CONFERENCE ON PATTERN RECOGNITION, CAMBRIDGE, UK AUG. 23-26, 2004, PISCATAWAY, N.J., USA, IEEE vol. 1, 23 August 2004 (2004-08-23), pages 412-424, discloses a method comprising the steps of scanning a hard copy document; subjecting the scanned document to an OCR process, so as to obtain a text file of the text of the document; subjecting the nouns and proper nouns in the text file to a Named Entities (NE) recognition process which includes a step of detecting OCR recognition errors by calculating a similarity measure (k) for a string of the text file and a corresponding string in a gazetteer and identifying the two strings with one another if their similarity measure exceeds a predetermined threshold value.

In this document, the task is to identify a sender's name in a fax cover page, so that the NE recognition may be limited to a sender's address field on the cover page, which field may be detected by means of a layout analysis.

U.S. Application Publication No. 2004/117192A1 and WO 97/38394 A disclose similar methods for identifying an address in an address block of a letter.

### SUMMARY OF THE INVENTION

The present invention aims at the more ambitious task of detecting named entities of any type in the full text of a scanned document. It is accordingly an object of the present invention to provide a method for automated document processing which includes NE recognition and is particularly suited for non-standardized documents that have originally been presented as hard copies and are degraded by OCR recognition errors.

A first embodiment of the method according to the present invention particularly addresses the problem that an OCR process frequently produces recognition errors, so that, in the electronic text file, some of the phrases that should be recognized as named entities will be misspelled, due to OCR recognition errors, and will therefore not be recognized as named entities in standard NE recognition routines, e.g. by reference to a gazetteer.

In the method according to an embodiment of the present invention, the phrases to be inspected are not just analyzed as they appear in the text file, but the possibility that these phrases are misspelled due to OCR recognition errors, is taken into account. Phrases are recognized as named entities even if they are only similar to but not identical with the patterns and/or phrases that are characteristic for the named entities to be detected.

Thus, the reliability of the NE recognition process is improved significantly in cases where the text file is “damaged” by OCR recognition errors. In this context, the “reliability” of the NE recognition is quantified by two measures that are known as “recall” and “precision.” Recall is the percentage of correct named entities that the process has identified, in relation to the total number of named entities that should have been found (as determined by human intervention). Precision is the percentage of those phrases that have been correctly identified (i.e. that actually are true named entities), in relation to the number of phrases that have (correctly or incorrectly) been identified as named entities. The step of detecting NEs with OCR/spelling errors according to the present invention will particularly improve the recall, because it increases the number of phrases that, in spite of being misspelled, can be recognized as patterns or can be found in a gazetteer. However, under certain circumstances, the detection of NEs with OCR/spelling errors may also improve the precision of the process.

It should be observed that the above-mentioned article of Mikheev et al. already describes an example where an NE process successfully identifies the OCR-damaged expression “U7ited States” in the phrase “U7ited States and Russia” as a named entity (location). However, this recognition is only due to an algorithm that concludes, from the fact that “Russia” was identified as a named entity and “U7ited States” and “Russia” are linked by the conjunction “and,” that “U7ited States” must also be the name of a location. It is not proposed in this document to provide a specific step for checking whether the sequence of characters “U7ited States” could be the result of an error in the OCR recognition of the original string “United States.”

For comparison, consider the phrase: “I have been to Rhodos and Ilike the Greek islands.” Here, the algorithm described above would identify “Rhodos” and “Ilike” as named entities (names of two Greek islands). A check for OCR errors would have shown that, most probably, the original text was: “I have been to Rhodos and I like the Greek islands.” This example also illustrates how the detection of OCR errors can improve the precision.

According to the present invention, the text file resulting from the OCR process is POS-tagged before or within the NE recognition process. There is a set of well-known algorithms to identify the morphological category of a word (so called POS (Part Of Speech) tags) in a presented text. Examples of such categories are verbs, articles, prepositions, ordinary nouns such as “house” or “garden” and proper nouns such as “Peter” or “Smith.” The proper nouns, which are labelled by the tag “/NNP” are of particular interest here, because they are likely to be or form part of a named entity. Thus, the subsequent NE process may focus onto those phrases that are composed of character strings that have been tagged with “/NNP.” In this way, the required amount of data processing is reduced significantly.

In a particularly preferred embodiment of the present invention, in order to limit the amount of processing to be performed, the NE recognition process comprises a first substep attempting to identify named entities by pattern analysis, a second substep attempting to identify named entities by reference to gazetteers (without taking possible OCR errors into account), and a third substep in which those proper nouns (or phrases composed of proper nouns), which have not been identified as named entities in the preceding substeps, are analyzed once again, but this time in consideration of possible OCR errors. In the simplest case, the third substep evaluates a similarity between the phrases in the text file and those in the gazetteers, and if the similarity is above a certain threshold, the pertinent phrase from the text file is recognized as a named entity.

It is preferable that named entities, misspelled or spelled correctly, that have been identified in the first substep by reference to patterns, are automatically entered into a gazetteer. Then, if the text file includes further occurrences, misspelled or not, of the same named entity, this named entity may be identified by reference to the gazetteer in the third substep.

In a more elaborate embodiment of the present invention, detection of OCR errors may also be involved in the pattern analysis, i.e. the phrases that still remain to be analyzed and/or the context thereof are checked for similarity with the predefined patterns that indicate named entities. It is also possible that the NE recognition step includes a step of checking all the words in the text file (or at least all the words in the context of possible named entities) for OCR errors, in order to improve the accuracy of a subsequent step of morphological analysis, such as POS tagging, which will then reveal the candidates for named entities with higher precision.

When all of the substeps of the NE recognition process has been completed, it may be left to the option of the user whether he wants to correct the misspelled named entities in the text file or whether he wants to leave them misspelled (but identified correctly).

What is required for detecting and possibly correcting OCR recognition errors is a suitable measure for evaluating the similarity between character strings of equal or approximately equal length. A number of known measures for that purpose are described in an article by Grzegorz Kondrak in “Identification of Confusable Drug Names: A new Approach and Evaluation Methodology,” proceedings of COLING, Geneva, Switzerland, 2004.

A simple measure is obtained just by counting the number of equal characters in the two strings and then dividing the sum by the length of these strings. If the strings have a different length, the sum can be divided either by the average length or by the length of the longer string. For example, the strings “pat” and “tap” have three identical characters, so that the similarity measure would be 1, i.e. identity, if the order in which the characters appear in the strings is disregarded. As an alternative, it may be required that the characters appear in the same order in both strings (the so-called “no crossing-links constraint”). Then, “pat” and “tap” would have only one character (“a”) in common, so that the similarity measure would only be 1/3.

A more general measure is obtained by counting the number of equal n-grams in the strings. An n-gram is a sequence of n adjacent characters in the order in which they appear in the strings. If n is >2, it may be desirable to increase the weight of the first and last characters in the strings, for example by adding blank segments before the first character and/or behind the last character of each string, these blank segments forming n-grams with the first and the last character, so that these characters will participate in as many n-grams as the internal characters of the string. Moreover, instead of distinguishing only between identity and non-identity of two n-grams, it is possible to assign a weight to each pair of n-grams, in accordance with the similarity or dissimilarity of the two of them.

It was found that the similarity measures that are known as “BI-SIM” and “TRI-SIM” are particularly suited for detecting NEs with OCR/spelling errors. These measures are described in the article of Kondrak and have been developed for the purpose of detecting and evaluating the amount of confusability between drug names. BI-SIM is based on the similarity of bi-grams or 2-grams (n=2) with the no-crossing-links constraint enforced and with the addition of a blank segment in front of each string. TRI-SIM is the equivalent thereof for n=3.

In general, the available algorithms for POS tagging are language specific. In a multi-lingual text, it is therefore convenient to first determine the language that is predominant in the text and then to select a POS algorithm for that language. Optionally, the step of determining the language or languages or the predominant language may be included in the OCR process.

The method according to the present invention is particularly well suited for multi-lingual texts, because most named entities are language-independent or are at least homologous to one another in different languages. For example, the English language name “Rome” of the Italian capital is homologous to the Italian name “Roma,” so that the process of detecting OCR recognition errors is capable of identifying these two names with one another. Thus, “Roma” can be recognized as a named entity if “Rome” is found in a gazetteer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow diagram illustrating the method according to an embodiment of the present invention;

FIG. 2 is an image of a text document to which an embodiment of the method according to the present invention is to be applied;

FIG. 3 shows a text file corresponding to the document of FIG. 2 and obtained in step S2 in FIG. 1;

FIG. 4 shows the text file obtained in step S4 in FIG. 1;

FIG. 5 shows the text file obtained in step S5 in FIG. 1;

FIG. 6 shows the text file obtained in step S6 in FIG. 1;

FIG. 7 shows the text file obtained in step S7 in FIG. 1; and

FIG. 8 is a diagram explaining the construction of a BI-SIM similarity measure.

### DETAILED DESCRIPTION OF THE PREFERED EMBODIMENTS

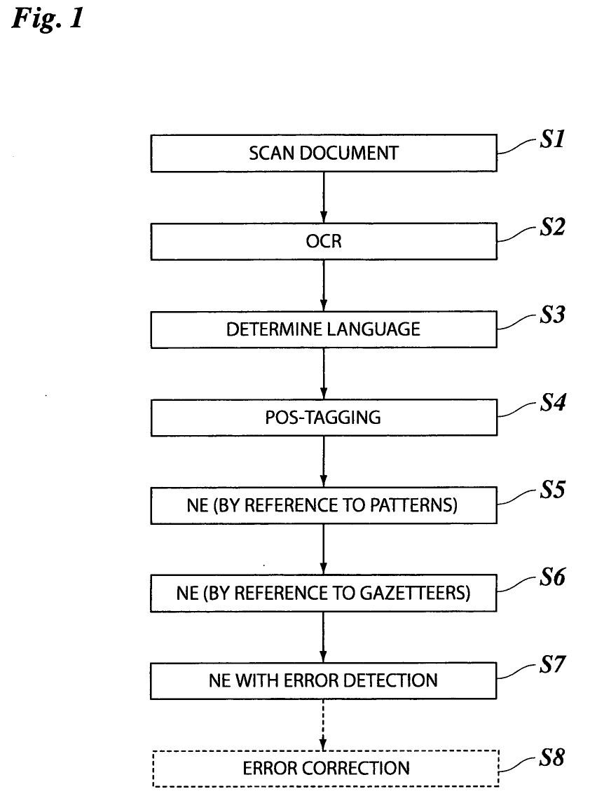

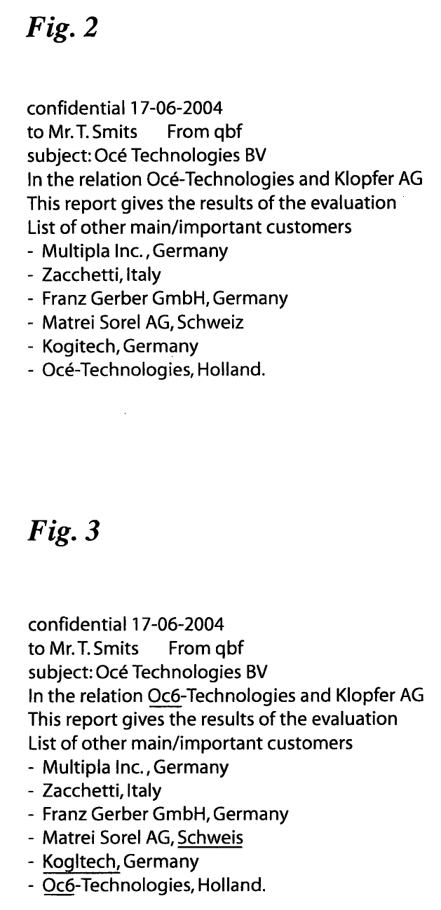

The present invention will now be described with reference to the accompanying drawings. As is shown in FIG. 1, a hard copy text document, the one shown in FIG. 2 for example, is scanned in Step S1. The result is an electronic file, e.g. a bitmap, representing the image on the hard copy document. Then, in step S2, this image is subjected to a known OCR process, which results in a text file as shown in FIG. 3.

Frequently, especially when the quality of the image on the hard copy document is poor, the OCR process leads to recognition errors. Examples of such errors have been underlined in FIG. 3. For example, the company name “Océ” has not been recognized correctly and is sometimes misspelled as “Oc6” in the text file. Similarly, the name “Schweiz,” which is the German language name of the country Switzerland, has been misspelled as “Schweis.” In the company name “Kogitech,” the letter “i” has erroneously been recognized as a “l.”

In general, the language in which the text has been written is not known beforehand, and the document may also be multi-lingual. This is why the language of the text or, in case of a multi-lingual text, the languages or the language that is predominant in the text are determined in step S3 in FIG. 1. Optionally, this step may be integrated in the OCR-step S2 and may then also be used for checking the words that have been recognized against a dictionary for the pertinent language, so as to improve the precision of the OCR process. It should be observed however that such a check will not improve the precision in the recognition of named entities, since the names of such entities are not normally found in a dictionary.

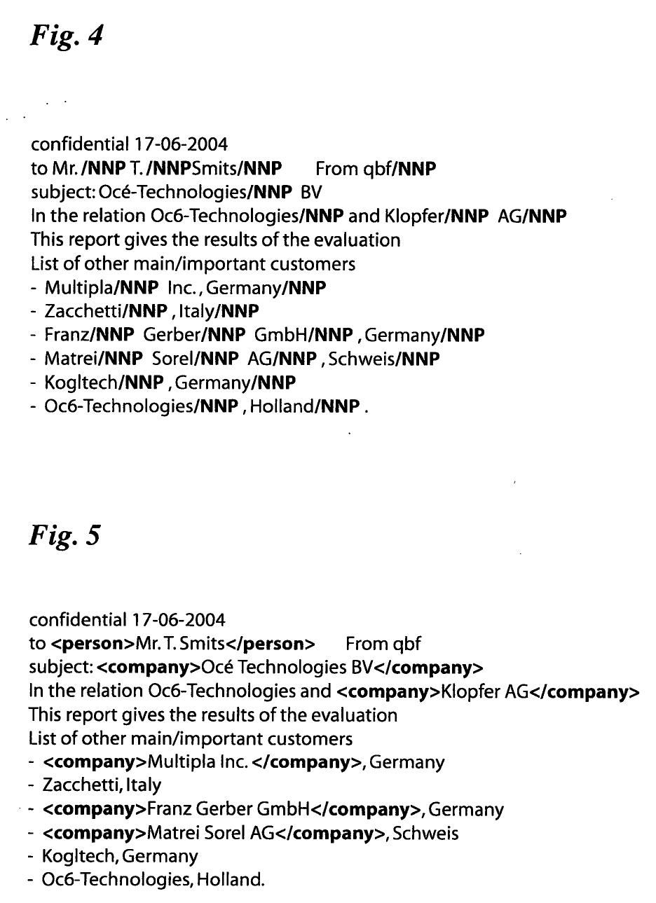

In step S4, the text file is POS-tagged (Part Of Speech tagging). The result is shown in FIG. 4. In general, a POS algorithm assigns a specific tag to each character string in the text file, depending on the (assumed) grammatical function of the string. However, since the detection of named entities focuses on proper nouns or proper names, FIG. 4 shows only the tags “/NNP” that have been assigned to such proper nouns.

Since the POS tagging algorithm depends on the grammatical structure of the language of the text, it is based on the language that has been determined in step S3. It is possible to determine different languages for different parts of the text. In many cases, however, one language will be predominant in the text (English in the example that is considered here), so that acceptable results are obtained if the POS-tagging is based on the predominant language only.

The subsequent steps S5, S6 and S7 in FIG. 1 implement the core of a Named Entity recognition process which seeks to identify and classify the strings that have been tagged with /NNP, and phrases composed of such strings, as named entities.

Step S5 is a first substep of the NE process, which attempts to identify the proper nouns or proper noun phrases by reference to characteristic patterns in the phrases themselves or in the context thereof. The result is illustrated in FIG. 5.

For example, it can be seen that the phrase “Mr. T. Smith” has been identified as a named entity, i.e. the name of a person, based on the pattern including the token “Mr.”. The start of the named entity phrase is indicated by a mark “<person>,” and the end of the phrase is marked by “</person,” wherein the word “person” classifies the named entity as the name of a person. Similarly, as is shown in the third line in FIG. 5, the phrase “Océ Technologies B.V.” (wherein Océ is not misspelled) has been identified as a company name. However, in the fourth line in FIG. 5, the process has failed to detect the phrase “OC6 Technologies” as a company name, not only because “Océ” has been misspelled, but also because the characteristic pattern feature “B.V.” is missing here. Other company names that include characteristic pattern features such as “AG,” “Inc.” or “GmbH”, have been identified correctly. On the other hand, some company names such as “Zacchetti” have not been identified in step S5, because they do not fit into a characteristic pattern.

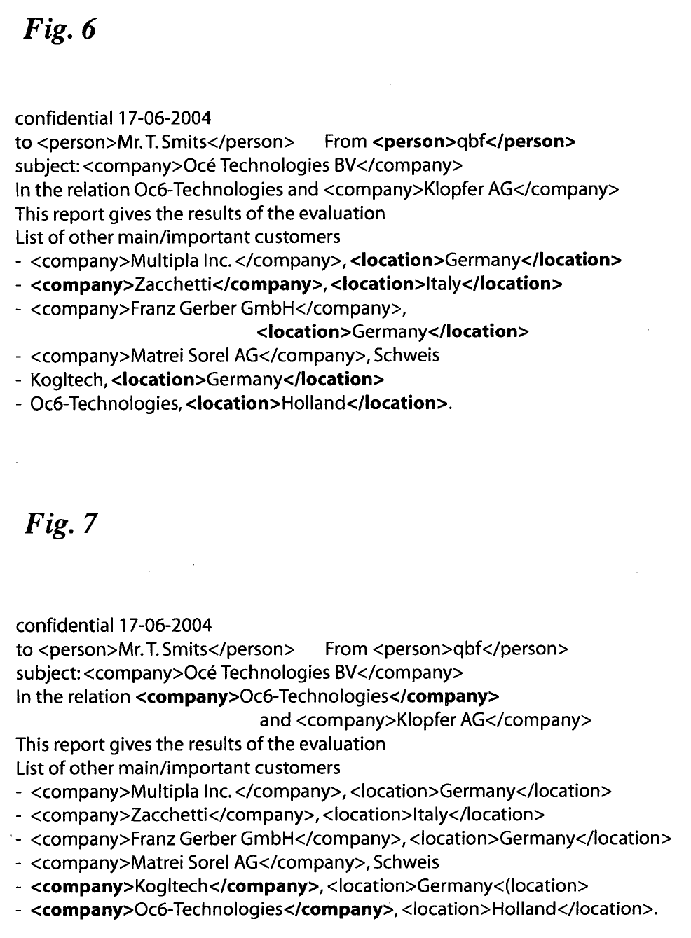

This is why, in the next substep, step S6, the text file is gone through once again, and the proper nouns and proper noun phrases that have not yet been identified as named entities are checked against one or more gazetteers, which list known named entities together with their respective categories. The result of this step is illustrated in FIG. 6, which shows that now, “Zacchetti” could be identified as a company name by reference to a gazetteer. Similarly, in the second line of the text, the abbreviation “qbf” could be identified as the name of a person, also by reference to a gazetteer. Likewise, the names of countries such as “Germany,” “Italy” and “Holland” are correctly identified as named entities referring to locations.

It should be observed that, in step S6, a phrase is only identified as a named entity when there is absolute identity between the phrase in the text file and a phrase appearing in at least one of the gazetteers. For this reason, the misspelled company names “Oc6 Technologies” and “Kogltech” have not been identified in step S6, nor have the misspelled country name “Schweis.”

In order to make the process more robust against misspelled words, resulting particularly from OCR recognition errors, a substep S7 has been added, which, in the simple example described here, attempts again to identify named entities by reference to gazetteers, but this time in combination with the detection of OCR recognition errors. More precisely, the phrases from the text file, that are being analyzed, are compared to phrases in the gazetteers, and a similarity measure is assigned to each pair of phrases and/or to each pair of words that form part of these phrases. If the similarity measure between a given pair of words or phrases is above a certain threshold level, then the phrase in the text file is identified as the named entity. For example, there is a high level of similarity between the character strings “Océ” and “Oc6,” and as a result, phrase “Oc6-Technologies” is now correctly identified as a company name. Likewise “Kogltech” is identified as a company name because of its similarity with the word “Kogitech” that is found in a gazetteer. Thus, as shown in FIG. 7, the step S7 results in a significantly improved reliability in the detection of the named entities appearing in the text file.

Then, optionally, a correction step S8 may be performed, in which the misspelled named entities (such as “Oc6”) are replaced by their correct versions (“Océ”).

A possible application of the method that has been described above is the task to anonymize a text. For example, the text shown in FIG. 2 includes sensitive information about a company (Océ-Technologies) and some of its business partners and should therefore be anonymized, i.e. the names of persons and companies and possibly also the locations should be replaced by neutral, non-disclosing names. Since the named entities have been detected with high reliability, the process of replacing these named entities can now be automated. In that case, it is of course unnecessary to correct the OCR recognition errors, since the misspelled expressions will be replaced, anyway.

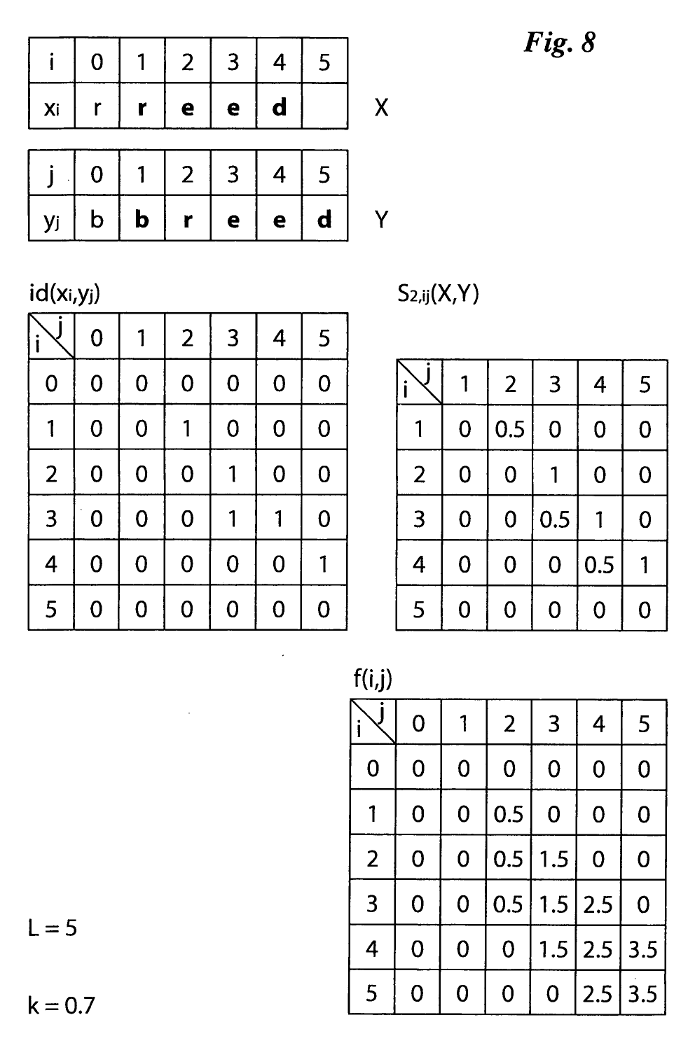

An example of a similarity measure, which is called BI-SIM and which is particularly well suited for detecting OCR recognition errors, will now be described in conjunction with FIG. 8.

By way of example, the similarity between two character strings X=reed and Y=breed shall be evaluated. Since the word “reed” has four characters, the string X has the length Lx=4. The characters of the string X are designated as xᵢ (i=0, . . . , 4), wherein x₀=x₁, i.e. x₀ is a copy of the first character and is added in front of the string. Similarly, the string Y has the length Ly=5, and its characters are designated as yⱼ (j=0, . . . , 5), with y₀=y₁. The purpose of adding a copy of the first character (rather than a blank space) at the front of each string is to favor words that have the same first character.

A function id (xᵢ, yⱼ) has the value “1” if xi=yⱼ and the value “0” otherwise. FIG. 8 shows the values of this function for the strings X and Y in matrix form. Since we are only interested in identities between characters of the two strings that appear in identical or at least neighboring positions, all off-diagonal elements in the matrix, except those in the two first sub-diagonals, may be set to zero.

By definition, an n-gram is an ordered subset of n characters in the string X or Y. Thus, for example, the first 2-gram in X (reed) will be “rr” and the second 2-gram in X will be “re.”

A similarity measure S_{n,ij} (X,Y) for n-grams can now be defined as follows:

$${S}_{n , ij} ( X , Y ) = ( 1 / n ) {\sum }_{k = 0}^{n} id ( {x}_{i - k} , {y}_{j - k} )$$

This measure describes the similarity between an n-gram that ends in the position i in the string X and an n-gram that ends in the position j in the string Y. By way of example, FIG. 8 shows, again in matrix form, the values of the similarity measure S_{2,ij} (X, Y). Since i and j now designate only the end positions of the 2-grams (pairs), i runs from 1 to 4 (all S_{2,5j} are zero), and j runs from 1 to 5. The BI-SIM similarity measure can now be defined by the following recurrence:

k=f(L,L)/L

with:

L=max(Lx,Ly)

and

f(i,j)=max [f(i−1,j), f(i,j−1), f(i−1,j−1)+S_{2,ij}(X,Y)]

f(i,j)=0, if i=0 or j=0

FIG. 8 shows the values of the function f(i,j) in matrix form. Again, all off-diagonal matrix elements, except those in the first two sub-diagonals, may be set to zero. Furthermore, the recurrence breaks off when i and j are equal to the length L of the longer one of the two strings.

In the example shown, L is 5, and f (L,L)=f (5,5) is 3.5, which gives k=0.7.

It is observed that the similarity of 0.7 between “reed” and “breed” is relatively high, even though these strings have only a single character in common (the “e” in the third position). The reason is that the maximum function (max) in the recurrence makes the measure sensitive to similarities between sub-strings that are shifted relative to one another by only one segment (such as the sub-string “reed” in the words “reed” and “breed”).

In general, k has values ranging from 0.0-1.0, and the value 1.0 is only reached when the two strings are absolutely identical.

Thus, two strings which differ in their length by at most one character can be identified with one another if their similarity measure exceeds a certain threshold value (<1) and this threshold value can be selected such that words of any length, that are misspelled due to an OCR recognition error, can be identified with their correct versions with considerably high recall and precision.

In a modified embodiment, the similarity measure TRI-SIM may be used, which is constructed in analogy to BI-SIM, but with n=3 and with two copies of the first character being added in front of each string.

According to yet another modification, the similarity measure Sn,ij for n-grams may be replaced by a similarity measure which is derived experimentally by determining the frequency of confusion between all possible n-grams in a typical OCR process. For example, in an OCR process, the single character (1-gram) “m” and the pair of characters (2-gram) “rn” are likely to be confused. It is therefore attractive to have a similarity measure which can compare not only 2-grams to 2-grams but also 2-grams to 1-grams. Since the measure BI-SIM, as described above, has been constructed to be tolerant against shifts of the characters by one segment, the construction principle of BI-SIM can well be adapted to the use of such 1-2-gram similarity measures that are specifically tailored to the detection of OCR errors.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for automated processing of hard copy text documents, said method comprising the steps of:
scanning the hard copy document;
subjecting the scanned document to an Optical Character Recognition (OCR) process, to obtain a text file of the text of the document; and
subjecting the text file to a Named Entities (NE) recognition process,
wherein the NE recognition process comprises a step of detecting OCR recognition errors in the text file.

2. The method according to claim 1, wherein the text documents are multi-lingual.

3. The method according to claim 1, further comprising a step of POS-tagging prior to or in the NE recognition process.

4. The method according to claim 1, wherein the NE recognition process comprises a substep of detecting named entities by reference to patterns.

5. The method according to claim 1, wherein the NE recognition process comprises a substep of detecting named entities by reference to at least one gazetteer.

6. The method according to claim 4, wherein the step of detecting OCR recognition errors is performed as a final substep in the NE recognition process and is combined with another NE recognition in the light of possible OCR recognition errors.

7. The method according to claim 5, wherein the step of detecting OCR recognition errors is performed as a final substep in the NE recognition process and is combined with another NE recognition in the light of possible OCR recognition errors.

8. The method according to claim 1, wherein the step of detecting OCR recognition errors further comprises the steps of:
calculating a similarity measure for a string of the text file and a corresponding string in a gazetteer; and
identifying the two strings with one another if their similarity measure exceeds a predetermined threshold value.

9. The method according to claim 8, wherein the similarity measure is based on n-grams with n=2-3, which enforces a no-crossing-links constraint.

10. The method according to claim 9, wherein the similarity measure is BI-SIM or TRI-SIM.

11. A computer program product comprising program code embodied on a computer-readable medium, said program code being adapted to cause, when run on a computer, the computer to perform a method for automated processing of hard copy text documents, said method comprising the steps of:
subjecting a scanned document file to an Optical Character Recognition (OCR) process, to obtain a text file; and
subjecting the text file to a Named Entities (NE) recognition process,
wherein the NE recognition process comprises a step of detecting OCR recognition errors in the text file.
